(19) United States
(12) Patent Application Publication
(10) Pub. No.: US 2004/0134299 A1
(43) Pub. Date: Jul. 15, 2004

(54) Control device for driving and braking a vehicle

(76) Inventors: Klaus-Jurgen Gotthardt, Hannberg (DE); Gerhard Haussermann, Leingarten (DE); Ralf Kremser, Mosbach (DE)

Correspondence Address: WALTER A. HACKLER, Ph.D., PATENT LAW OFFICES, SUITE B, 2372 S.E. BRISTOL, NEWPORT BEACH, CA, 92660-0755, US

(21) Appl. No.: 10/645,133

(22) Filed: Aug. 20, 2003

(30) Foreign Application Priority Data
Sep. 3, 2002 (EP) 02 019 600.2

(51) Int. Cl. G05G 11/00; G05G 13/00

(52) U.S. Cl. 74/483 R

(57) ABSTRACT

A control device for driving and braking a vehicle, preferably a rail vehicle, comprises a first (1) and a second (2) linearly movable operating lever which are disposed next to each other and can be coupled to each other.

This application claims Paris Convention priority of EP 02019600.2 filed Sep. 3, 2002 the complete disclosure of which is hereby incorporated by reference

### BACKGROUND OF THE INVENTION

### Description

The invention relates to the field of control technology and to a control device for driving and braking a vehicle, preferably a vehicle on rails.

Devices of this type are known per se. Desired values for rail vehicle drives are e.g. manually predetermined by operating levers, converted by a measuring unit into electrical signals and transmitted to a drive control. The drive control forms, together with a drive, a control system which sets a speed or a driving force of the vehicle or a braking force e.g. in accordance with the predetermined desired value. Under certain conditions, it is possible and desirable to calculate optimum desired values and set the drive accordingly. It is e.g. possible to calculate, on the basis of time schedule, vehicle and travel distance information, an optimum travelling speed or tractive power for a rail vehicle, with which the time schedule is adhered to with minimum energy consumption or which permits stops at desired positions. For safety reasons it is, however, not desired to set the drive to a predetermined optimum travelling speed since the driver no longer has complete and permanent control of the speed.

It is the underlying purpose of the present invention to develop a control device structure of a vehicle with modular construction to permit simple and inexpensive adjustment to the respective individual case of use.

### SUMMARY OF THE INVENTION

This object is achieved in accordance with a control device of claim 1. The invention is characterized by two preferably parallel, closely adjacent operating levers (shift set-point adjuster) with identical or different path length (e.g. 200/120 mm) for operation with one hand.

The handles of the two operating levers may be ergonomic and be made from a material which is pleasant for the hands.

The following functions may be provided in the handles:

mechanical or electrical mutual locking of the two handles for operation with one hand;

mechanical or electrical release of the above-mentioned function;

signal keys, such as SiFa keys, as push button (electrical contact);

signal key or switch (trigger electrical contact for locomotive);

signal key or switch for further functions (electrical contact and unlocking);

signal key for electrical locking of the respective lever in a certain position, e.g. zero position;

mechanically actuated latch for locking and unlocking the respective lever in a certain position;

a vibrator to transfer a signal to the operator via mechanical vibrations of the handle;

optical signals via LED;

scroll elements;

The handles may have different geometrical shapes to ensure that the operator can feel which function is currently actuated when it is dark.

The two handles must be arranged such that operation with one hand is convenient and trapping of the fingers is in any case prevented.

Each operating lever may be provided with locking positions or key positions via the regulating range. These locking or key positions may be uniformly or irregularly distributed over the regulating distance.

The locking or key positions may be provided with different locking/key moments.

Locking/key positions may be optionally triggered or released by latches or signal transmitters in the handles (ratchet locking).

Each operating lever may be connected to a mechanically or electrically acting brake. The brakes may be effective over the entire regulating range or over partial ranges. The brakes may have varying braking forces in different regions. The electrically effective brake may be formed e.g. in a magneto-liquid manner with feedback means.

Each operating lever may be provided with a mechanically effective restoring means, e.g. a return spring. The restoring means may be effective in the entire regulating range or only in partial ranges. The restoring forces may vary in different regions. The restoring function may also be externally controlled via servomotors.

Each operating lever is provided with a linear path detection. The path detection may be redundant. The following detection possibilities may be provided:

opto-electronic path detection via opto-electronic encoders absolute transmitters, e.g. 8 bit-Gray-code, binary code or analog output;

laser-based transmitters;

potentiometers (electrically conducting plastics potentiometers or wire precision potentiometers);

inductively effective systems;

electrical switching elements (forced/guided contacts) at defined positions of the regulating range. E.g. stepped contacts, zero position contacts, SB position, fill position etc.

A contact (guided) may be provided at the end stop in the direction of the brakes, which introduces the fast braking process via pneumatic or hydraulic path transmitters (valves).

The electrical signals produced by the lever deflection can be further processed via a bus system.

The above-mentioned path detection elements can be controlled linearly or via suitable transformation of a linear motion into rotation.

The guidances for the linear motion of the operating levers may be covered (Teflon foil, roll, toothed belt). The cover should be a module such that it can be exchanged without dismounting the control device.

Illumination of scales or engravings with different colours which change depending on the individual operating levers, e.g. LEDs may be provided. The changing colours and illumination signs also contain these engravings.

The linear guidance may be provided by:

spindle drive

ball thread

flat guidance

dove-tailed guidance

prismatic guidance

ball sleeve

toothed rack guidance

Transformation of the linear motion of the operating levers into rotation of further components may be provided by means of:

toothed belts

chains

toothed rack gears

The small size is advantageous. The play can be minimized via a tension roller. An electric contact, possibly redundant, which is provided on the tension roller ensures safety control of the function of the toothed belt or chain.

The electric components are electrically connected via plug connectors. The compressed air is connected via plug connectors. The hydraulic connection is effected via plug connectors. The driving-braking lever or tractive power braking actuator can be locked mechanically with a further device, e.g. travelling direction switch, key switch and or speed set-point adjuster.

Further advantages of the invention can be extracted from the description and the drawing. The features mentioned above and below may be used in accordance with the invention either individually or collectively in arbitrary combination. The embodiment shown and described is not to be understood as exhaustive enumeration but has exemplary character for describing the invention.

The drawing schematically shows a preferred embodiment of the invention which is explained in more detail with reference to the drawing.

### BRIEF DESCRIPTION OF THE DRAWING

FIGS. 1 through 10 show positions of two cooperating operating levers for driving and braking a rail vehicle.

### DESCRIPTION OF THE PREFERRED EMBODIMENT

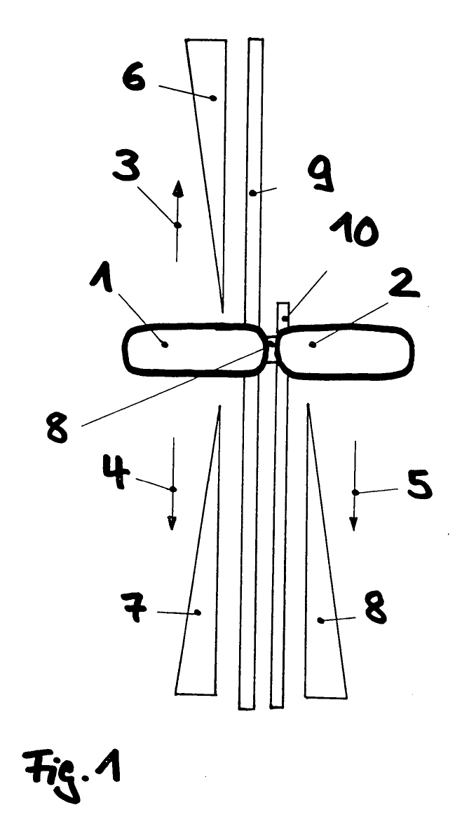

FIG. 1 shows the zero position of two operating levers 1 and 2 which are disposed in the driver's cab of a rail vehicle (locomotive) at the driver's table to move and brake the rail vehicle. A linear motion of the operating lever 1 in the direction of arrow 3 sets the tractive power, i.e. acceleration of the rail vehicle. A linear motion of the operating lever 1 in the direction of arrow 4 sets an electric brake for generating a braking effect on an electro-dynamic basis. A linear motion of the operating lever 2 in the direction of arrow 5 generates a braking effect by means of an indirectly acting compressed air brake. The increase of the set tractive power and the braking forces on the basis of the zero position, is indicated by the bars 6 to 7. Rails 9 and 10 for the operating levers 1 and 2 have locking points for setting predetermined tractive and braking forces. The operating lever 1 is provided with a so-called SiFa key and the operating lever 2 has a locomotive trigger key. The operating levers 1 and 2 have a coupling 8. The SiFa (safety travelling switch) brakes the train or the locomotive when the driver is not able to respond to prevent any danger to other trains. The basic principle of SiFa is very simple: The locomotive driver must actuate a key every 30 seconds (which varies depending on the vehicle or SiFa type) to communicate to the locomotive that he/she is conscious.

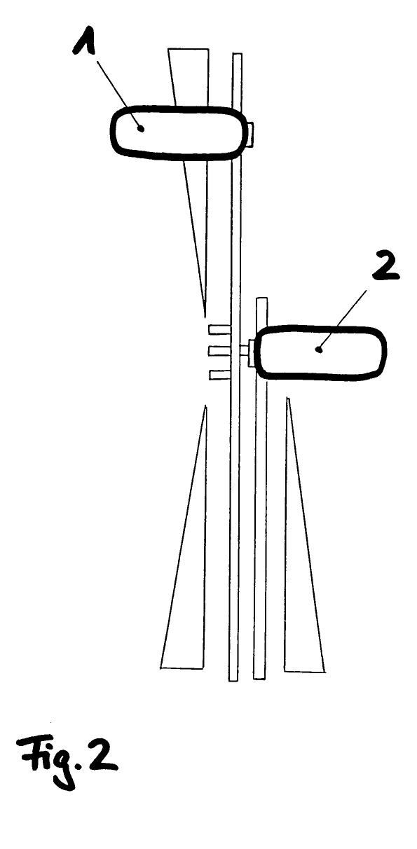

FIG. 2 shows preselection of a value for the tractive power by means of the operating lever 1 when the SiFa key is actuated. The operating levers 1 and 2 are decoupled.

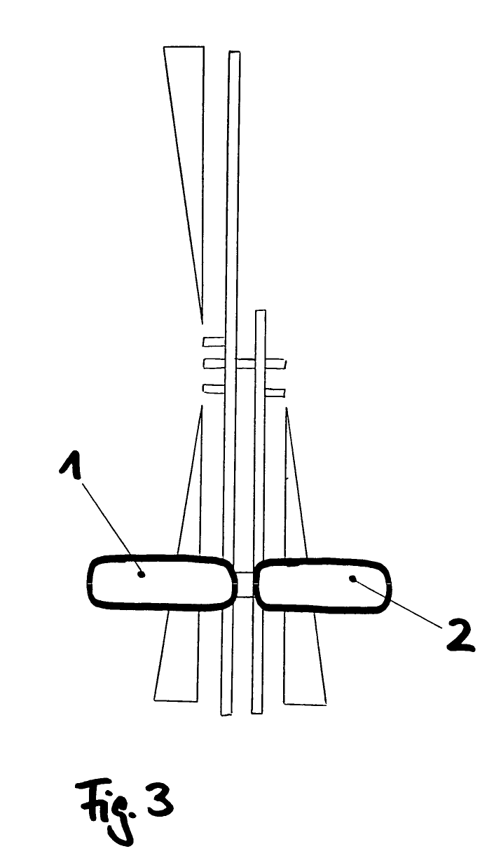

FIG. 3 shows coupled braking by means of both operating levers 1 and 2.

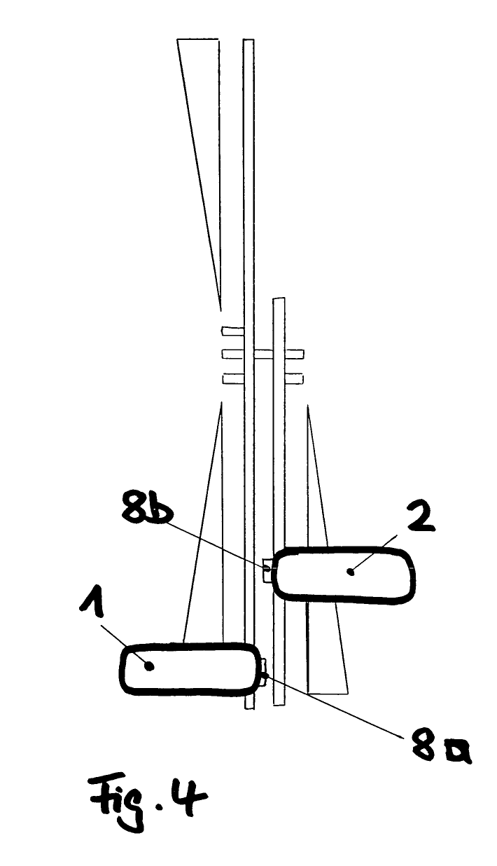

In addition to coupled braking, individual braking is also possible which is shown in FIG. 4 wherein the operating levers 1 and 2 are decoupled (see coupling means 8a and 8b).

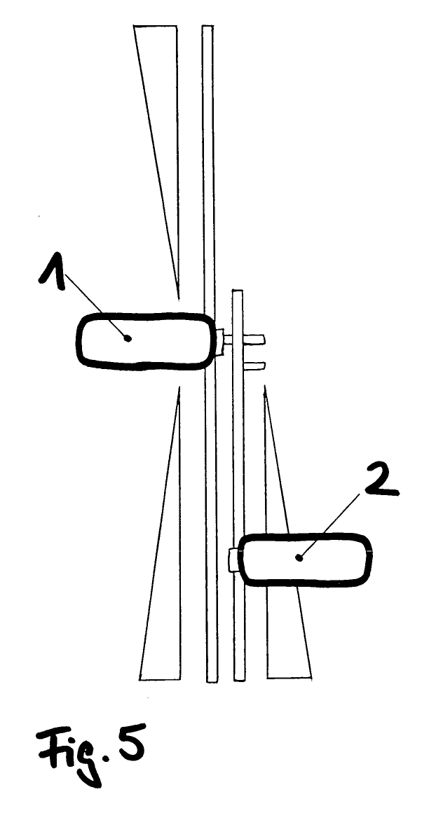

FIG. 5 shows a sole brake setting of the indirectly acting compressed air brake via the operating lever 2 which is decoupled from the operating lever 1. The operating lever 1 is in the zero position (no preselection of tractive power value).

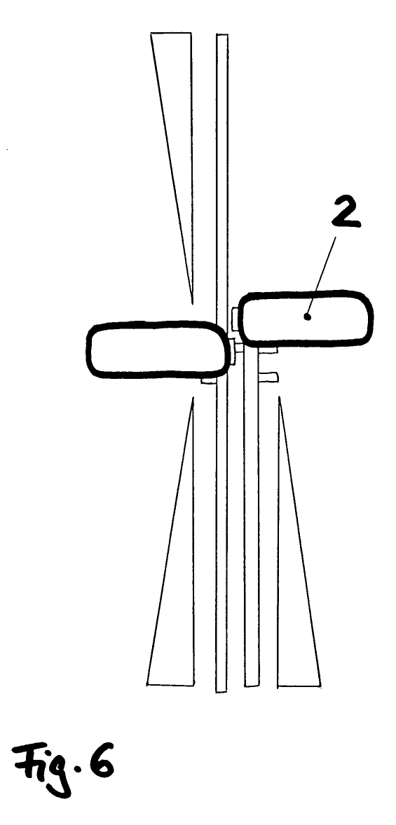

FIG. 6 shows that the operating levers 1 and 2 also permit a so-called filling stroke. Actuation of a driver braking valve by means of the operating lever 2 energizes a magnet valve and compressed air is additionally released producing a larger cross-sectional opening in the connection between main compressed air line and main braking line and the pressure rises as long as it is actuated. After termination of the filling stroke, the pressure is again decreased.

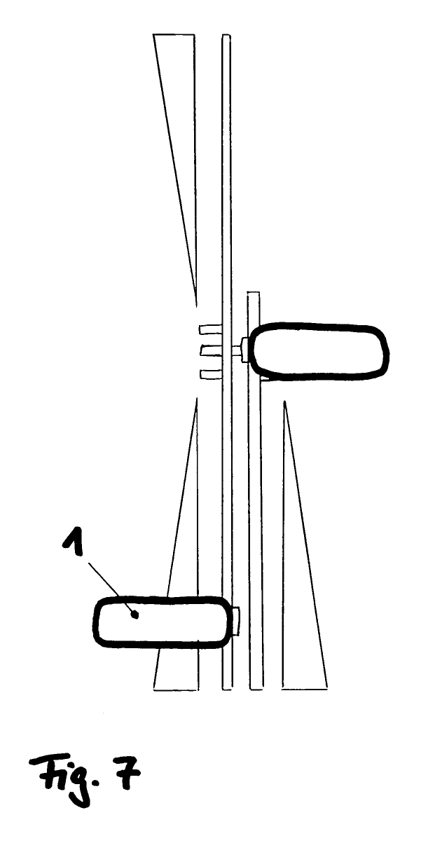

In accordance with FIG. 7, the electric brake can be actuated alone (operating lever 1).

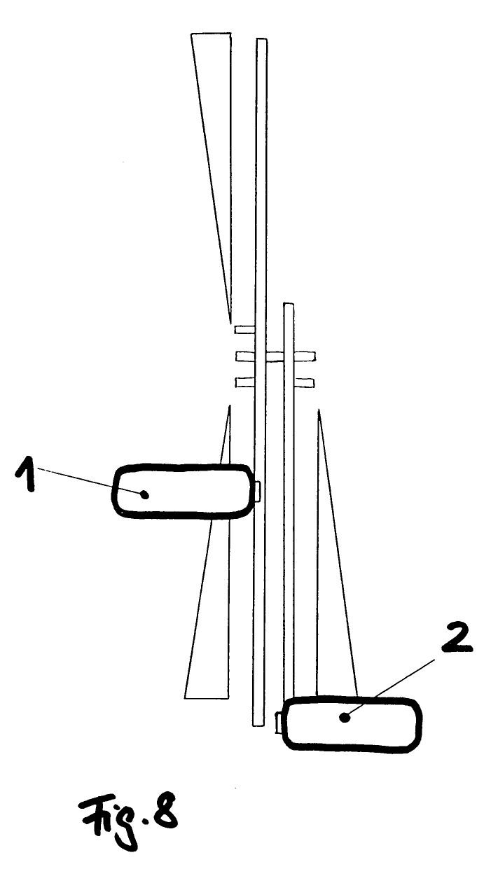

FIG. 8 shows decoupled braking with electric brake and compressed air brake through actuation of both decoupled operating levers 1 and 2.

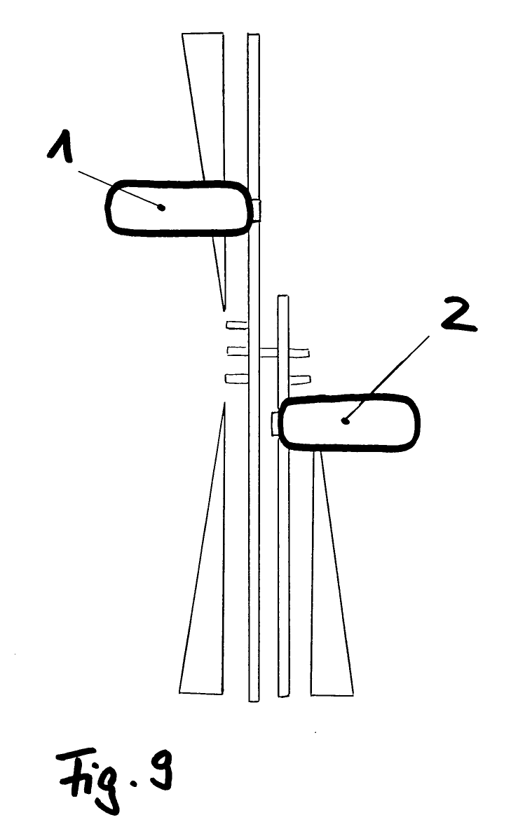

Also driving (operating lever 1) against the indirectly acting compressed air brake (operating lever 2) is feasible (see FIG. 9).

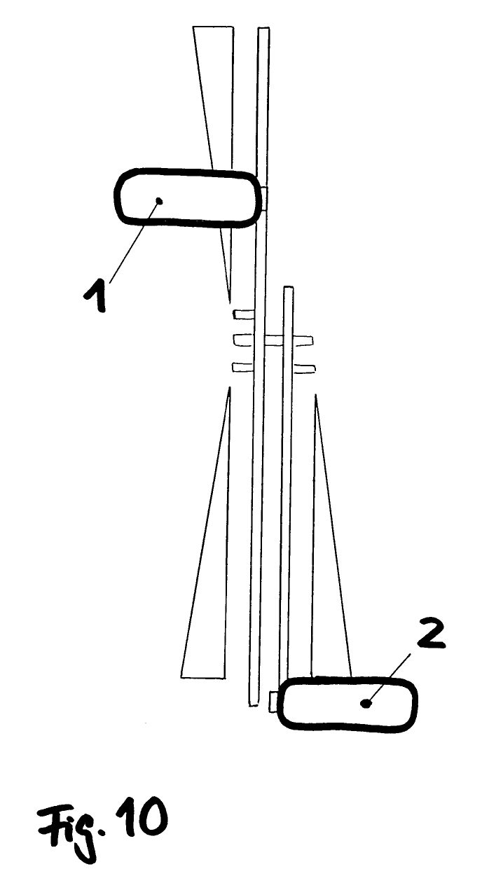

When the operating levers 1 and 2 are decoupled (driving) rapid braking is possible as shown by the lever positions of FIG. 10.

### List of Reference Numerals

1 operating lever

2 operating lever

3 direction of arrow

4 direction of arrow

5 direction of arrow

6 bar

7 bar

8 bar

9 rail

10 rail

I claim:

1. Control device for driving and braking a vehicle, preferably a rail vehicle, comprising a first (1) and a second (2) linearly movable operating lever which are disposed next to each other and can be coupled to each other.

2. Control device according to claim 1, characterized in that the first operating lever (1) is provided for setting acceleration or tractive power and actuating an electric brake and the second operating lever (2) is provided for actuating an indirectly acting compressed air brake.

3. Control device according to claim 1, characterized in that the operating levers (1, 2) have switches or keys.
